(19) United States
(12) Patent Application Publication
(10) Pub. No.: US 2013/0106548 A1
(43) Pub. Date: May 2, 2013

(54) Inductor device

(71) Applicants: Ming Yen Hsieh, Taoyuan Hsien (TW); Ching Chi Hsieh, Taoyuan Hsien (TW); Hsiang Chung Yang, Taoyuan Hsien (TW)

(72) Inventors: Ming Yen Hsieh, Taoyuan Hsien (TW); Ching Chi Hsieh, Taoyuan Hsien (TW); Hsiang Chung Yang, Taoyuan Hsien (TW)

(73) Assignee: Tai-Tech Advanced Electronics Co., Ltd.

(21) Appl. No.: 13/317,716

(22) Filed: Oct. 26, 2011

(51) Int. Cl. H01F 27/02

(52) U.S. Cl. 336/90

(57) ABSTRACT

An inductor device includes a core having a flange attached to one of the end portions, a winding engaged onto the core, and a covering member engaged onto the core and the winding, the covering member includes a number of particles, and includes an outer contour identical to that of the first flange. The covering member includes a quadrilateral shape having four outer surfaces flush with four outer surfaces of the flange. The covering member includes a thickness and dimension (h) equal to that of the flange. The covering member is made of a material selected from a heat curing resin and an ultraviolet curing resin. The particles are selected from ferrite or magnetic powders or particles.

### BACKGROUND OF THE INVENTION

1. Field of the Invention

The present invention relates to an inductor device, and more particularly to an inductor device including an outer covering material or member having a uniform thickness or width or outer peripheral portion for suitably increasing the inductance or for providing a stabilized inductance.

2. Description of the Prior Art

Typical electric inductors comprise a core, and an electric wiring or winding attached or mounted or secured or engaged onto the core.

For example, U.S. Pat. No. 3,737,995 to Utner discloses one of the typical plastics covered with coils also comprising a general tubular core, and an electric wiring or winding attached or mounted or secured or engaged onto the core, and an outer covering or coating applied or engaged onto the outer peripheral portion of the tubular core and the electric wiring or winding.

However, the outer covering or coating do not include a uniform thickness or width or outer peripheral portion such that the inductance of the typical plastics covered with coils may not be stable or stabilized.

U.S. Pat. No. 4,149,135 to Roespel et al. discloses another typical electric coil comprising a flanged ferrite core, and an electric wiring or winding attached or mounted or secured or engaged onto the core.

However, no outer covering or coating have been provided or applied or engaged onto the outer peripheral portion of the core such that the inductance of the typical electric coils may not be stable or stabilized.

U.S. Pat. No. 5,751,203 to Tsutsumi discloses a further typical electric inductor comprising a flanged ferrite core, and an electric wiring or winding attached or mounted or secured or engaged onto the core.

However, no outer covering or coating have been provided or applied or engaged onto the outer peripheral portion of the core such that the inductance of the typical electric coils may not be stable or stabilized.

The present invention has arisen to mitigate and/or obviate the afore-described disadvantages of the conventional coils or inductor devices.

### SUMMARY OF THE INVENTION

The primary objective of the present invention is to provide an inductor device including an outer covering material or member having a uniform thickness or width or outer peripheral portion for suitably increasing the inductance or for providing a stabilized inductance.

In accordance with one aspect of the invention, there is provided an inductor device comprising a core including a first end portion and a second end portion, and including a first flange provided on the first end portion of the core, and extended radially and outwardly therefrom, a winding engaged onto the core, and a covering member engaged onto the core and the winding, the covering member includes a number of particles engaged therein, and includes an outer contour identical to that of the first flange for providing a stabilized inductance.

The covering member includes a quadrilateral shape having four outer surfaces flush with four outer surfaces of the first flange. The covering member includes a thickness and dimension (h) equal to that of the first flange. The covering member is made of a material selected from a heat curing resin and an ultraviolet curing resin.

The particles are selected from magnetic particles and magnetic powders, magnetic attractive particles, ferrite powders and particles or the like.

The core includes a second flange provided on the second end portion of the core, and extended radially and outwardly therefrom. The covering member includes a thickness and dimension (h) greater than that of the second flange of the core.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of an inductor device in accordance with the present invention;

FIG. 2 is a cross sectional view of the inductor device, taken along lines 2-2 of FIG. 1;

FIG. 3 is another cross sectional view similar to FIG. 2, illustrating the other arrangement of the inductor device; and

FIG. 4 is a further cross sectional view similar to FIGS. 2 and 3, illustrating the further arrangement of the inductor device.

### DETAILED DESCRIPTION OF THE PREFERRED EMBODIMENT

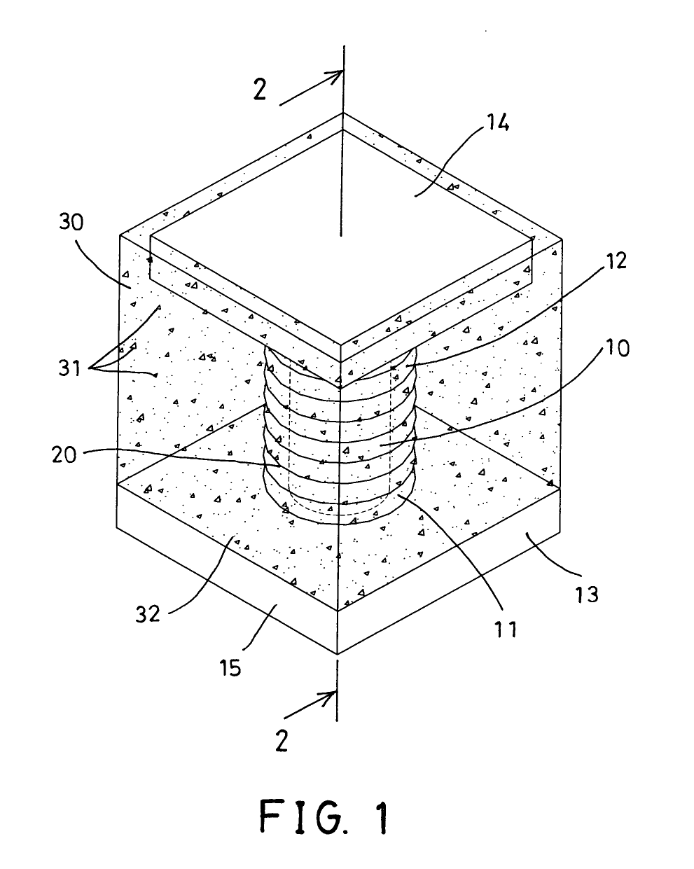

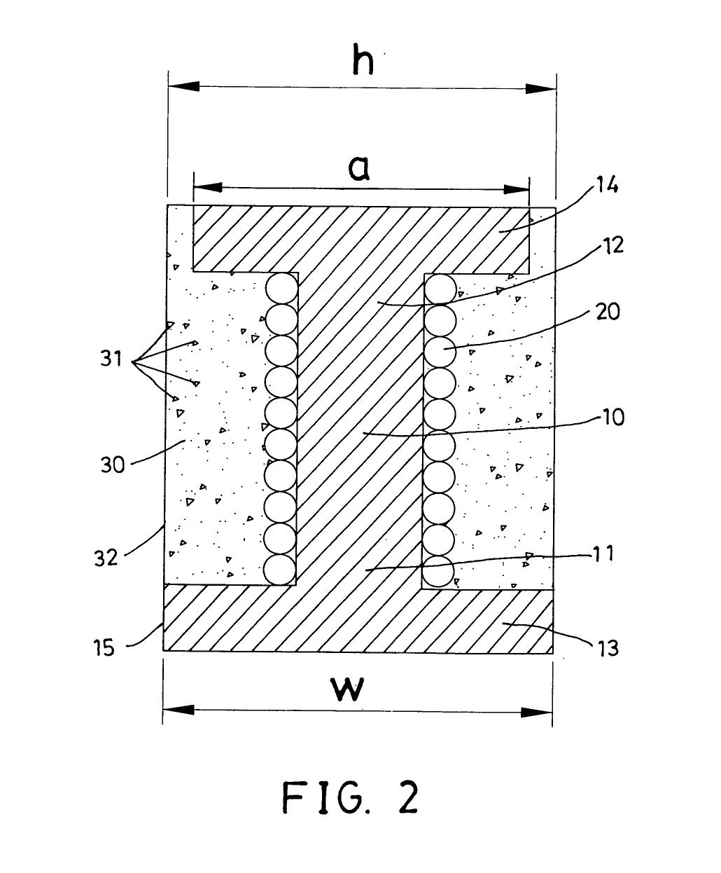

Referring to the drawings, and initially to FIGS. 1 and 2, an inductor device in accordance with the present invention comprises a central or middle or primary core 10 including a lower or first end portion 11 and an upper or second end portion 12, and including a lower or base or first flange 13 attached or mounted or provided or secured to the lower or first end portion 11 of the core 10, and/or formed integral with the core 10, and extended radially and outwardly therefrom, and an upper or second flange 14 attached or mounted or provided or secured to the upper or second end portion 12 of the core 10, and/or formed integral with the core 10, and extended radially and outwardly therefrom.

An electric wiring or winding 20 is attached or mounted or secured or engaged onto or around the core 10, and preferably engaged between the lower or base or first flange 13 and the upper or second flange 14. An outer covering material or member 30 is further provided and attached or mounted or applied or engaged onto or around the core 10 and the winding 20 and may be made of a material selected from a heat curing resin, or an ultraviolet curing resin, or the like, and may include a number of magnetic particles or magnetic attractive particles 31 disposed or engaged therein, and may be made of or selected from the ferrite powders or particles, the magnetic powders or particles, or the like.

The lower or base or first flange 13 and/or the upper or second flange 14 may include a circular or rectangular or square or quadrilateral shape, or other shapes, and the first flange 13 may include an outer diameter or thickness or length or width or dimension (W, FIG. 2) smaller or equal to or greater than the outer diameter or thickness or length or width or dimension (a) of the upper or second flange 14, and the outer covering material or member 30 may include an outer diameter or thickness or length or width or dimension (H) smaller or equal to or greater than the outer diameter or thickness or length or width or dimension (W) of the first flange 13.

For example, as shown in FIGS. 1 and 2, the outer covering material or member 30 may include a thickness or length or width or dimension (h) equal to the thickness or length or width or dimension (W) of the first flange 13, and/or greater than the thickness or length or width or dimension (a) of the upper or second flange 14, and may include an outer contour or shape similar or identical to that of the first flange 13 and/or the upper or second flange 14, such as a rectangular or square or quadrilateral shape having four side or outer surfaces 32 aligned with or flush with the corresponding four side or outer surfaces 15 of the first flange 13 for providing a stabilized inductance for the inductor device.

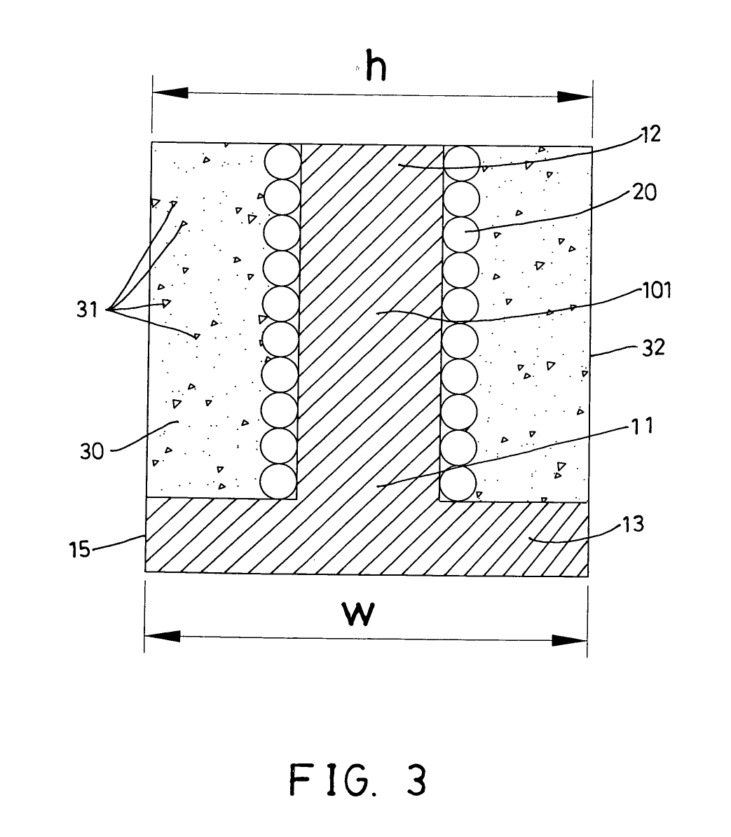

Alternatively, as shown in FIG. 3, the core 101 may include only the lower or base or first flange 13 attached or mounted or secured to the lower end portion 11 of the core 10, and may have no upper or second flange provided on the upper end portion 12 of the core 10; and the outer covering material or member 30 may also include an outer contour or shape similar or identical to that of the first flange 13, such as a rectangular or square or quadrilateral shape having four side or outer surfaces 32 aligned with or flush with the corresponding four side or outer surfaces 15 of the first flange 13, and having a thickness or length or width or dimension (h) equal to the thickness or length or width or dimension (W) of the first flange 13 for providing a stabilized inductance for the inductor device.

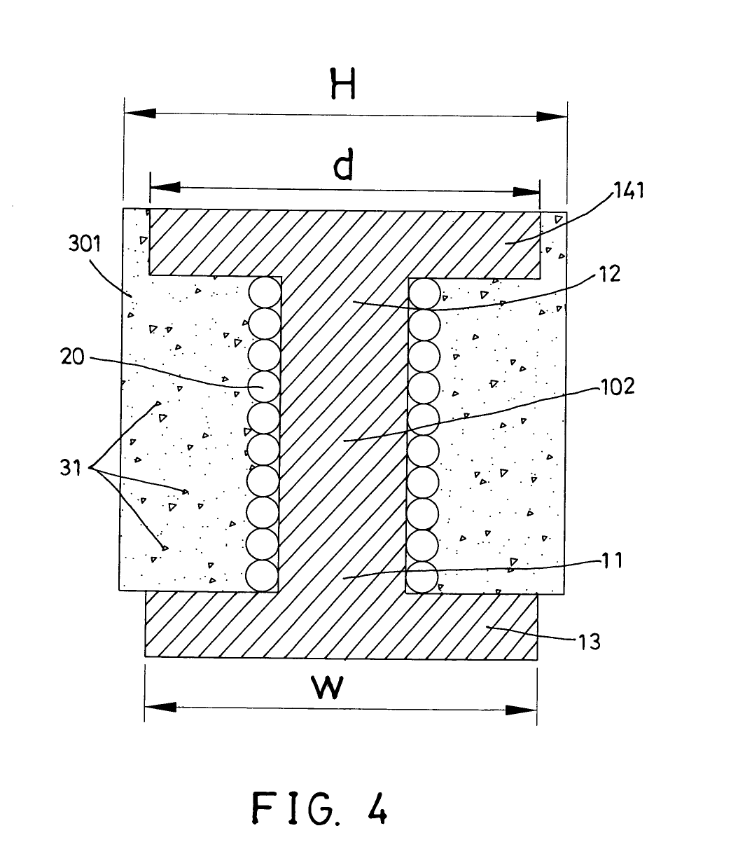

Further alternatively, as shown in FIG. 4, the core 102 may include an upper or second flange 141 attached or mounted or secured to the upper end portion 12 of the core 10, and the upper or second flange 14 includes a thickness or length or width or dimension (d) equal to the thickness or length or width or dimension (W) of the first flange 13, and the outer covering material or member 301 may include a thickness or length or width or dimension (H) greater than the thickness or length or width or dimension (W) of the first flange 13 and the dimension (d) of the upper or second flange 141, and may include an outer contour or shape similar or identical to that of the first flange 13 and the second flange 141.

Accordingly, the inductor device in accordance with the present invention includes an outer covering material or member having a uniform thickness or length or width or outer peripheral portion for suitably increasing the inductance or for providing a stabilized inductance.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An inductor device comprising:
a core including a first end portion and a second end portion, and including a first flange provided on said first end portion of said core,
a winding engaged onto said core, and
a covering member engaged onto said core and said winding,
wherein said covering member includes a plurality of particles engaged therein, and includes an outer contour identical to that of said first flange.

2. The inductor device as claimed in claim 1, wherein said covering member includes a quadrilateral shape having four outer surfaces flush with four outer surfaces of said first flange.

3. The inductor device as claimed in claim 1, wherein said covering member includes a thickness and dimension (h) equal to that of said first flange.

4. The inductor device as claimed in claim 1, wherein said covering member includes a width and dimension (h) equal to that of said first flange.

5. The inductor device as claimed in claim 1, wherein said covering member is made of a material selected from a heat curing resin and an ultraviolet curing resin.

6. The inductor device as claimed in claim 1, wherein said particles are selected from magnetic particles and magnetic powders.

7. The inductor device as claimed in claim 1, wherein said particles are selected from magnetic attractive particles.

8. The inductor device as claimed in claim 1, wherein said particles are selected from ferrite powders and particles.

9. The inductor device as claimed in claim 1, wherein said core includes a second flange provided on said second end portion of said core.

10. The inductor device as claimed in claim 9, wherein said covering member includes a thickness and dimension (h) greater than that of said second flange of said core.
